(19) United States
(12) Patent Application Publication
(10) Pub. No.: US 2007/0006485 A1
(43) Pub. Date: Jan. 11, 2007

(54) Clothes drying machine

(75) Inventor: Jin Doo Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/365,679

(22) Filed: Mar. 2, 2006

(30) Foreign Application Priority Data
Jul. 8, 2005 (KR) 10-2005-0061871

(51) Int. Cl. F26B 19/00; F26B 11/02

(52) U.S. Cl. 34/603; 34/88; 34/89

(57) ABSTRACT

A clothes drying machine, which minimizes gaps or steps generated in connected portions between panels of an external case. The clothes drying machine includes an external case having a plurality of panels, which are interconnected, wherein the panels include first panels respectively having connection portions, and a second panel having ends covering the outer surfaces of the corresponding connection portions and inner support portions extended from an inner surface of the second panel to support inner surfaces of the connection portions

### CROSS-REFERENCE TO RELATED APPLICATIONS

This application claims the benefit of Korean Patent Application No. 10-2005-0061871, filed Jul. 8, 2005, in the Korean Intellectual Property Office, the disclosure of which is incorporated herein by reference.

### BACKGROUND OF THE INVENTION

1. Field of the Invention

The present invention relates to a clothes drying machine. More particularly, to a clothes drying machine which prevents connected portions of panels of an external case of the clothes drying machine from being separated from each other and being damaged.

2. Description of the Related Art

Generally, a conventional clothes drying machine is an apparatus for drying laundry in a rotary drum using hot air passing through the inside of the rotary drum under the condition that the rotary drum containing the laundry is rotated, and includes the rotary drum rotatably installed in an external case, a driving unit for driving the rotary drum, and air blowing unit for blowing air. The external case of the clothes drying machine includes a plurality of panels, which are interconnected.

Korean Patent Laid-open Publication No. 10-2005-58012 discloses an external case of a clothes drying machine. The external case of the clothes drying machine is a hexahedral structure obtained by interconnecting a base, side panels, a rear panel, a front panel, an upper panel, and a control panel installed between the front end of the upper panel and the upper end of the front panel.

Since the external case of the clothes drying machine includes a structure in which a plurality of the panels are interconnected, when parts of the panels are damaged due to the use of the clothes drying machine for a long time, gaps or steps are generated in connected portions between the panels, thereby deteriorating the external appearance of the clothes drying machine.

In the conventional clothes drying machine, a user may place heavy laundry on the upper panel, or external force may be applied to the front panel when the user places or takes laundry into or out of the rotary drum. Thereby, connected portions between the upper panel and the control panel or connected portions between the front panel and the control panel are damaged, and gaps or steps may be generated in the connected portions.

When the gaps or steps are generated in the connected portions between the upper or front panel and the control panel, the control panel is easily exposed to the eyes of the user, thereby deteriorating the external appearance of the clothes drying machine.

### SUMMARY OF THE INVENTION

Accordingly, it is an aspect of the present invention to provide a clothes drying machine, which minimizes gaps or steps generated in connected portions between panels of an external case.

Additional aspects and/or advantages of the invention will be set forth in part in the description which follows and, in part, will be apparent from the description, or may be learned by practice of the invention.

The foregoing and/or other aspects of the present invention are achieved by providing a clothes drying machine, which reinforces connected portions between panels of an external case of the clothes drying machine to prevent damage to the connected portions.

It is another aspects of the present invention to provide a clothes drying machine having an external case including a plurality of panels, which are interconnected, wherein the panels include first panels respectively having connection portions, and a second panel having ends covering outer surfaces of the corresponding connection portions and inner support portions extended from an inner surface of the second panel to support inner surfaces of the connection portions.

The panels further include a support panel to support the inner support portions for preventing the connected portions between the first and second panels from being damaged.

The connection portions of the first panels include a step having a thickness corresponding to that of the second panel.

The second panel includes a control panel having operating means for controlling the operation of the clothes drying machine.

A plurality of the inner support portions are formed on the inner surface of the second panel and spaced from each other by a designated interval.

The inner support portions protrude from the inner surface of the second panel and extend towards the inner surfaces of the corresponding connection portions.

It is another aspects of the present invention to provide a clothes drying machine having an external case, the external case including a front panel, a control panel, a lower end of which is connected with an upper end of the front panel, and an upper panel, a front end of which is connected with the upper end of the control panel, wherein connection portions are respectively formed on ends of the front panel and the upper panel so that outer surfaces of the connection portions are covered by ends of the control panel, and inner support portions to support inner surfaces of the connection portions are extended from an inner surface of the control panel.

The external case further includes an upper support panel to support the inner support portions for preventing connected portions between the control panel and the front panel from being damaged.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 illustrates a sectional view of a clothes drying machine in accordance with an embodiment of the present invention;

FIG. 2 illustrates an exploded perspective view of an external case of the clothes drying machine shown in FIG. 1;

FIG. 3 illustrates a perspective view of a control panel of the clothes drying machine in accordance with an embodiment of the present invention;

FIG. 4 illustrates an enlarged view of the portion “A” of FIG. 1; and

FIG. 5 illustrates an enlarged view of the portion “B” of FIG. 1.

### DETAILED DESCRIPTION OF THE PREFERRED EMBODIMENTS

Reference will now be made in detail to the embodiment of the present invention, an example of which is illustrated in the accompanying drawings, wherein like reference numerals refer to like elements throughout. The embodiment is described below to explain the present invention by referring to the figures.

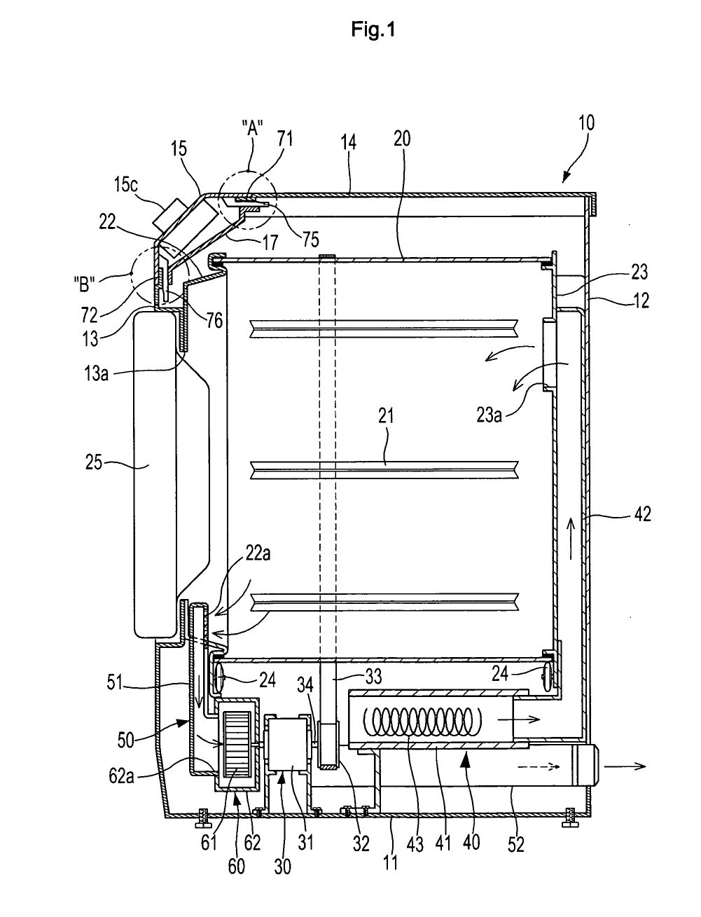

A clothes drying machine in accordance with the present invention, as shown in FIG. 1, comprises a rotary drum 20 rotatably installed in an external case 10, and a driving unit 30 to drive the rotary drum 20. The clothes drying machine further comprises an air suction channel 40 and an air discharge channel 50 to circulate air into the rotary drum 20, and an air blowing unit 60.

The rotary drum 20 comprises a cylindrical structure, front and rear surfaces of which are opened, and comprises a plurality of lifters 21 protruding in a convex shape from an inner surface of the rotary drum 20 to lift and to drop laundry therein. A front support plate 22 and a rear support plate 23 to rotatably support the rotary drum 20 and respectively covering the front and rear opened surfaces of the rotary drum 20 are installed in the external case 10, and rollers 24 to support the rotary drum 20 are installed on lower ends of the front support plate 22 and the rear support plate 23.

An opening 13a to place or take laundry into and out of the rotary drum 20 is formed through the front surface of the external case 10, and a door 25 to open and close the opening 13a is installed on the front surface of the external case 10.

The driving unit 30 comprises a driving motor 31 installed in the lower portion of the inside of the external case 10, and a pulley 32 and a rotary belt 33 to transmit the driving force of the driving motor 31 to the rotary drum 20.

The air suction channel 40 guides external air to the inside of the rotary drum 20. The air suction channel 40 comprises a lower air suction duct 41 installed in the external case 10 below the rotary drum 20, and a rear air suction duct 42 installed in the rear of the rear support plate 23 for connecting an air suction hole 23a formed through an upper portion of the rear support plate 23 to the lower air suction duct 41. A heater 43 to heat inhaled air is installed in the lower air suction duct 41.

The air discharge channel 50 guides air in the rotary drum 20 to the outside. The air discharge channel 50 comprises a front air discharge duct 51 to connect an air discharge hole 22a formed through a lower portion of the front support plate 22 to an inlet 62a of the air blowing unit 60 installed below the rotary drum 20, and a rear air discharge duct 52 installed in a lower portion of the inside of the external case 10 to guide discharged air to the outside.

The air blowing unit 60 comprises an air blast fan 61 installed on a shaft 34 of the driving motor 31, the shaft 34 being extended from the driving unit 30 in the opposite direction of the pulley 32, driving the rotary drum 20, and an air blowing case 62 surrounding the air blast fan 61 and having the inlet 62a and an outlet (not shown) respectively connected with the front air discharge duct 51 and the rear air discharge duct 52.

When the above-described clothes drying machine generally dries laundry, the rotary drum 20 is rotated by an operation of the driving motor 31, and the laundry contained in the rotary drum 20 is lifted and dropped by the rotation of the rotary drum 20. Simultaneously, external air is circulated into the rotary drum 20, and dries the laundry in the rotary drum 20. Further, the laundry is rapidly dried by causing the heater 43 to heat the air inhaled through the lower air suction duct 41.

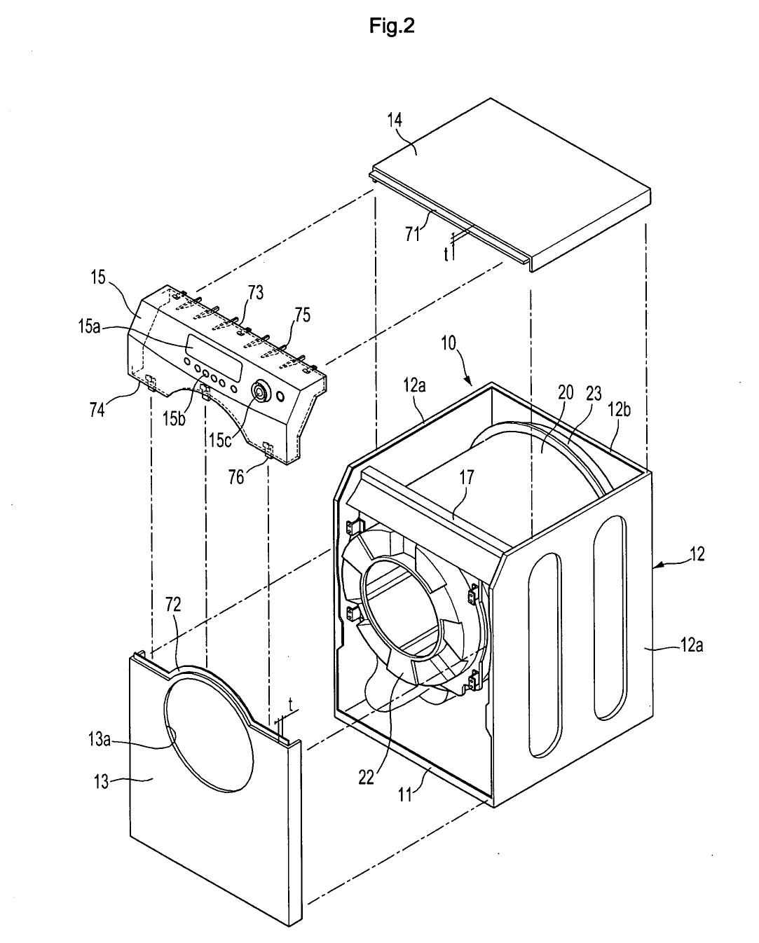

The external case 10, as shown in FIG. 2, comprises a base panel 11, a main frame 12 having both side portions 12a and a rear portion 12b, which are integrally formed, a front panel 13 covering the front surface of the main frame 12, an upper panel 14 covering the upper surface of the main frame 12, and a control panel 15 installed on the upper portion of the front panel 13. These panels are interconnected by fixing screws or connection means latched onto each other.

An upper support panel 17 to support side portions 12a of the main frame 12 and to support inner parts of connected portions between the control panel 15 and the upper panel 14 and inner parts of connected portions between the control panel 15 and the front panel 13 is installed in the control panel 15, thereby preventing the connected portions from being damaged. Both ends of the upper support panel 17 are fixed to the inner surfaces of both side portions 12a of the main frame 12.

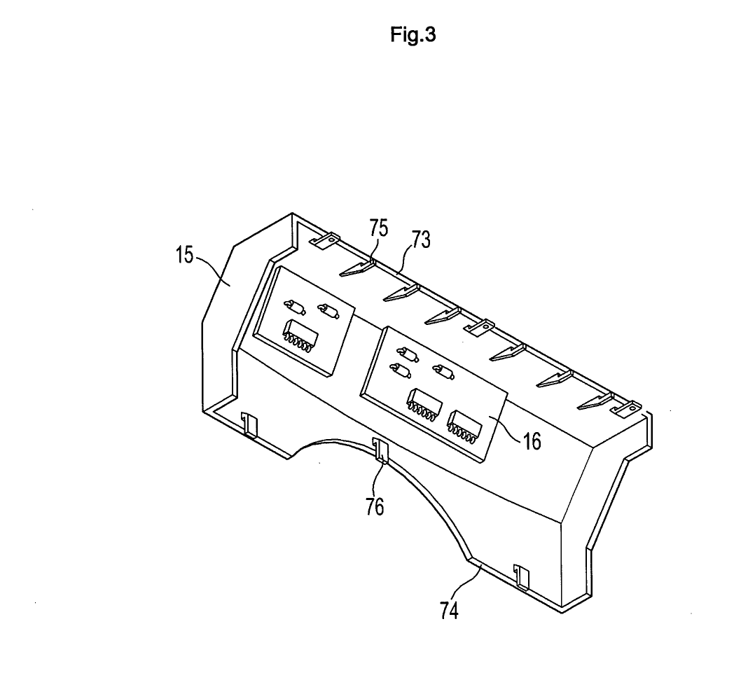

The control panel 15 comprises a display unit 15a to display an operating state of the clothes drying machine, and a plurality of operation buttons 15b and an operation knob 15c to control an operation of the clothes drying machine. Further, as shown in FIG. 3, circuit boards 16 are installed on the rear surface of the control panel 15.

In FIG. 2, an upper end 73 of the control panel 15 is connected with the upper panel 14, and an lower end 74 of the control panel 15 is connected with the upper end of the front panel 13. In order to perform the above connections, a first connection portion 71 is formed on the front end of the upper panel 14 connected with the upper end 73 of the control panel 15, and a second connection portion 72 is formed on the upper end of the front panel 13 connected to the lower end 74 of the control panel 15.

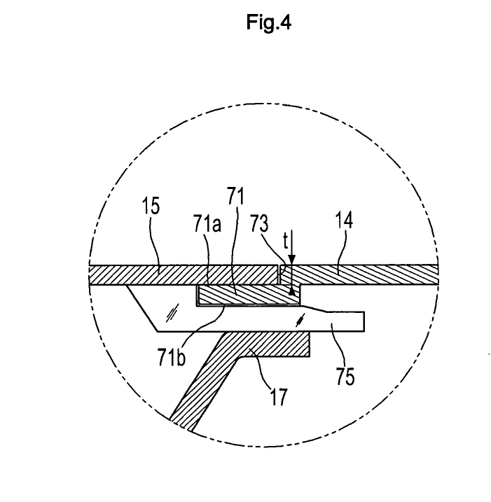

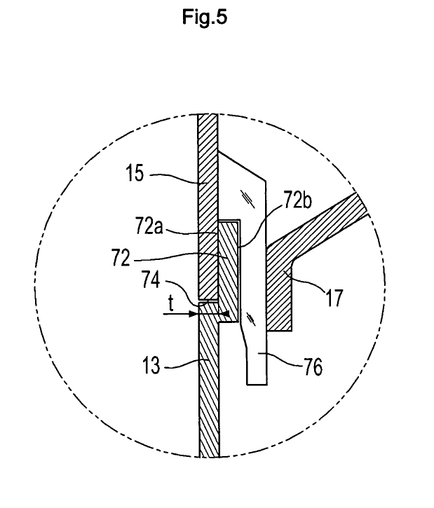

When the control panel 15 is connected with the upper panel 14 and the front panel 13, the upper end 73 of the control panel 15 covers the outer surface 71a of the first connection portion 71 of the upper panel 14, as shown in FIG. 4, and the lower end 74 of the control panel 17 covers the outer surface 72a of the second connection portion 72 of the front panel 13, as shown in FIG. 5.

The first connection portion 71 of the upper panel 14 and the second connection portion 72 of the front panel 13 are bent towards an inside of the external case 10, and are then extended in the longitudinal direction, thereby having a step with a thickness (t) corresponding to that of the control panel 15. The steps of the first and second connection portions 71 and 72 cause the outer surfaces of the front, upper and control panels 13, 14 and 15 to be leveled when the control panel 15 is connected with the upper panel 14 and the front panel 13, thereby providing smooth external appearance of the clothes drying machine.

In FIGS. 3 and 4, first inner support portions 75, which are extended from the inner surface of the control panel 15 towards the inner surface 71b of the first connection portion 71 of the upper panel 14 so as to support the inner surface 71b of the first connection portion 71 when the upper end 73 of the control panel 15 is connected with the first connection portion 71 of the upper panel 14, are formed on the upper end 73 of the control panel 15. The first inner support portions 75 are protruded from the inner surface of the control panel 15, and are extended towards the inner surface 71b of the first connection portion 71. A plurality of the first inner support portions 75 are spaced from each other by a designated interval. In FIG. 4, the first inner support portions 75 are supported by the upper end of the upper support panel 17.

Further, as shown in FIGS. 3 and 5, second inner support portions 76, which are extended from the inner surface of the control panel 15 towards the inner surface 72b of the second connection portion 72 of the front panel 13 so as to support the inner surface 72b of the second connection portion 72 when the lower end 74 of the control panel 15 is connected to the second connection portion 72 of the front panel 13, are formed on the lower end 74 of the control panel 15. The second inner support portions 76 are protruded from the inner surface of the control panel 15, and are extended towards the inner surface 72b of the second connection portion 72. A plurality of the second inner support portions 76 are spaced from each other by a designated interval. As shown in FIG. 5, a part of the second inner support portions 76 are supported by the lower end of the upper support panel 17.

In FIG. 4, when the control panel 15 and the first connection portion 71 of the upper panel 14 are interconnected, the upper end 73 of the control panel 15 covers the outer surface 71a of the first connection portion 71, and the first inner support portions 75 support the inner surface 71b of the first connection portion 71, thereby being firmly connected to the first connection portion 71 of the upper panel 14 without separation. Further, the upper support panel 17 supports the first inner support portions 75 so that connected portions between the control panel 15 and the upper panel 14 are reinforced, thereby preventing gaps or steps generated in the connected portions between the control panel 15 and the upper panel 14 even when external force is applied to the upper panel 14 and the control panel 15.

Further, in FIG. 5, the connecting relation between the second connection portion 72 of the front panel 13 and the lower end 74 and the second inner support portions 76 of the control panel 15 is the same as the above connecting relation. Further, the lower end of the upper support panel 17 supports a part of the second inner support portions 76, thereby preventing gaps or steps generated in the connected portions between the control panel 15 and the front panel 13 even when external force is applied to the front panel 13. Accordingly, since gaps or steps are not generated in the connected portions between the panels of the external case 10 (particularly, the portions of the panels connected with the control panel 15), the clothes drying machine of the present invention has an aesthetically pleasing external appearance.

Although this embodiment describes the inner support portions 75 and 76 respectively formed on the connected portions between the control panel 15 and the upper panel 14 and the connected portions between the control panel 15 and the front panel 13 so that gaps or steps are not generated in the connected portions, the present invention is not limited to the above embodiment. Such a connection structure may be applied to connected portions between other panels of the external case 10. That is, this connection structure may be applied to connected portions between the front panel 13 and the main frame 12 and connected portions between the upper panel 14 and the main frame 12.

As apparent from the above description, the present invention provides a clothes drying machine, in which connected portions between panels of an external case are supported by inner support portions, thereby minimizing gaps or steps generated in the connected portion between the panels. Thus, the clothes drying machine has an aesthetically pleasing external appearance.

Further, since the connected portions between the panels of the external case, particularly the connected portions between a control panel and other panels, are supported by a separate support panel i.e., an upper support panel, it is possible to prevent the connected portions between the panels from being damaged even when external force is applied to the front and upper surfaces of the external case. Thereby, the clothes drying machine minimizes gaps or steps generated in the connected portion between the panels, thus having an aesthetically pleasing external appearance.

Although an embodiment of the invention has been shown and described, it would be appreciated by those skilled in the art that changes may be made in this embodiment without departing from the principles and spirit of the invention, the scope of which is defined in the claims and their equivalents.

What is claimed is:

1. A clothes drying machine having an external case, the external case comprising:
a plurality of panels, which are interconnected, wherein the panels comprise:
a first panel having a connection portion, and
a second panel having an end covering an outer surface of a corresponding connection portion and an inner support portion extended from an inner surface of the second panel for supporting an inner surface of the connection portion.

2. The clothes drying machine as set forth in claim 1, wherein the panels further comprise a support panel supporting the inner support portion to prevent a connected portion between the first and second panels from being damaged.

3. The clothes drying machine as set forth in claim 1, wherein the connection portion of the first panel comprises a step having a thickness corresponding to that of the second panel.

4. The clothes drying machine as set forth in claim 1, wherein the second panel is a control panel comprising an operating means for controlling an operation of the clothes drying machine.

5. The clothes drying machine as set forth in claim 1, wherein a plurality of the inner support portions are formed on the inner surface of the second panel and are spaced from each other by a designated interval.

6. The clothes drying machine as set forth in claim 1, wherein the inner support portions are protruded from the inner surface of the second panel and are extended towards the inner surface of the corresponding connection portion.

7. A clothes drying machine comprising:
an external case comprising:
a front panel,
a control panel, a lower end of which is connected with an upper end of the front panel, and
an upper panel, a front end of which is connected with an upper end of the control panel, wherein connection portions are respectively formed on ends of the front panel and the upper panel so that outer surfaces of the connection portions are covered by ends of the control panel, and inner support portions to support inner surfaces of the connection portions are extended from an inner surface of the control panel.

8. The clothes drying machine as set forth in claim 7, wherein the external case further comprises an upper support panel to support the inner support portions to prevent connected portions between the control panel and the front panel from being damaged.

9. The clothes drying machine as set forth in claim 7, wherein the connection portions comprise a step with a thickness corresponding to that of the control panel.

10. The clothes drying machine as set forth in claim 7, wherein a plurality of the inner support portions are spaced from each other by a designated interval.

11. The clothes drying machine as set forth in claim 7, wherein the inner support portions are protruded from the inner surface of the control panel and are extended towards the inner surfaces of the corresponding connection portions.

12. A clothes drying machine, comprising:
an external case comprising:
a front panel;
an upper panel; and
a control panel having inner support portions, wherein the upper panel and the front panel each comprise connection portions extended toward the control panel to connect with the control panel, and the inner support portions of the control panel support the connection portions of the upper panel and the front panel when the front panel, the upper panel and the control panel are interconnected.

13. The clothes drying machine of claim 12, wherein the connection portions comprise a step having a same thickness as that of the control panel.

14. The clothes drying machine of claim 12, further comprising a support panel positioned on an inner surface of the control panel to support the inner support portions of the control panel, and to prevent damage at a connection between the front panel and the control panel and a connection between the control panel and the upper panel.
